(19) United States
(12) Patent Application Publication
(10) Pub. No.: US 2026/0235298 A1
(43) Pub. Date: Aug. 13, 2026

(54) COOKING APPLIANCE COMPRISING A SPECIFIC GUIDE CARRIAGE FOR A RETRACTABLE DOOR

(71) Applicant: BSH Hausgeräte GmbH, Munich (DE)

(72) Inventors: Thorsten Rausch, Karlsruhe (DE); Michael Essert, Östringen (DE)

(21) Appl. No.: 19/149,569

(22) PCT Filed: Feb. 26, 2024
(86) PCT No.: PCT/EP2024/054769

§ 371 Date: Jul. 21, 2025

(30) Foreign Application Priority Data
Mar. 1, 2023 (DE) 10 2023 201 863.2

(51) Int. Cl. F24C 15/02; E05D 15/58

(52) U.S. Cl. CPC F24C 15/026; E05D 15/582

(57) ABSTRACT

A cooking appliance includes a door for closing a cooking chamber, a housing designed to form a stowage space into which the door is retractable, a guide carriage, and a guide part arranged in the stowage space for guiding the guide carriage in a retracting movement of the door into the stowage space. The guide part includes, when viewed in a vertical direction of the cooking appliance, a top guide track and a separate bottom guide track. The guide carriage includes guiding elements which make contact with the top and bottom guide tracks in order to guide the guide carriage, with at least one of the guiding elements resting on the bottom guide track from above and at least a further one of the guiding elements making contact with the top guide track from below.

The invention relates to a cooking appliance comprising a door for closing a cooking chamber and comprising a housing in which a stowage space is formed into which the door can be retracted, wherein a guide part is arranged in the stowage space, on which guide part a guide track for a guide carriage of the cooking appliance is formed in order to guide the retracting movement of the door into the stowage space.

Cooking appliances with retractable doors which are coupled to guide carriages are disclosed in DE 10 2018 201 950 A1 and DE 10 2020 208 891A1, wherein the guide carriages are guided by rollers in slotted guides.

Moreover, a cooking appliance with a retractable door is disclosed in DE 10 2015 226 009A1. In this case the stowage space for the door is also defined by lateral, vertical, in particular plate-like, side walls. Guide tracks for a slotted guide carriage, or a guide carriage, are also configured in these side walls which represent technical parts. In this embodiment, these guide tracks are configured far down in these technical parts, when viewed in the vertical direction of the cooking appliance and thus also in the vertical direction of these technical parts. As a result, a guide movement of the door can obtain a specific sequence. In particular, in this embodiment it is provided that a front end and a rear end of this guide track are configured practically immediately adjacent to a lower edge of this technical part. The door is thus arranged far down at the start of the movement and at the end of the movement.

Such an embodiment restricts the retractability of relatively wide doors. This is because in this context the installation space is not only limited in terms of the width but also in terms of the height.

It is the object of the present invention to provide a cooking appliance with a retractable door, wherein the guidance of the guide carriage is improved. In this context, therefore, a concept is intended to be made possible in which the flexibility is improved regarding the use of different doors.

This object is achieved by a cooking appliance which has the features according to claim 1.

One aspect of the invention relates to a cooking appliance comprising a door for closing a cooking chamber. The cooking appliance also comprises a housing in which a stowage space is formed. The door can be retracted into this stowage space. The stowage space is a space which is separate from a cooking chamber of the cooking appliance. Food can be introduced into the cooking chamber for preparation. A guide part is arranged in the stowage space, on which guide part a guide track for a guide carriage of the cooking appliance is configured for guiding the retracting movement of the door into the stowage space.

The guide part has a first top guide track, when viewed in the vertical direction of the cooking appliance. The guide part also has a second bottom guide track which is separate from the first top guide track, when viewed in the vertical direction. The guide carriage has a plurality of separate guiding elements which make contact with the two guide tracks in order to guide the guide carriage, in particular simultaneously during the movement of the guide carriage.

At least one guiding element is arranged so as to rest on the bottom guide track from above. At least one further guiding element is arranged so as to make contact with the top guide track from below.

Such a concept thus enables the guide carriage to be able to be moved particularly advantageously and with minimized tolerances.

In one exemplary embodiment, the guide carriage has at least one side guiding element which is separate from the guiding elements and which can be placed on a lateral guide track of the cooking appliance for lateral guidance of the guide carrier, in particular at least temporarily when moving the guide carriage, when viewed in the width direction of the cooking appliance.

As a result, in addition to the very specific concept with the guiding elements and the guide tracks, which are specifically arranged relative to one another in the vertical direction and which interact, and thus with a particularly tolerance-minimized movement of the guide carriage in the vertical direction relative to the guide part, it is now also possible to achieve a tolerance-minimizing guidance in a direction perpendicular thereto, namely in the width direction. This provides a concept in which an undesired deflection movement of the guide carriage relative to the guide part and/or the lateral guide track is avoided in two spatial directions, namely in the vertical direction and the width direction of the guide carriage, by guiding elements which are explicitly present and which mechanically interact with specific guide tracks. This concept enables the movement, which is intended to be performed in particular in the depth direction, to be particularly accurately maintained. This also has significant advantages for the movement of the door into the stowage space or out of the stowage space. Thus relatively complex movement sequences of the door can now also be fulfilled in a particularly accurate manner and with minimized tolerances. This also has the advantage that a jamming or spreading or tilting of the door, in particular of the door leaf, can be reduced during the retracting movement or during the extending movement into the stowage space or out of the stowage space. Thus undesirable forces acting on the aforementioned components can be significantly reduced or avoided, so that the wear of these components can also be significantly reduced over the course of the service life.

The guiding elements, which make contact with the top guide track and the bottom guide track, can also be denoted as vertical guiding elements. The guiding elements are provided, in particular, to predetermine the position of the guide carriage relative to the guide part in the vertical direction. The top and the bottom guide tracks can also be denoted as vertical guide tracks.

In one exemplary embodiment, the at least one side guiding element is arranged between two front guiding elements and two rear guiding elements, when viewed in the depth direction of the cooking appliance. Thus the side guiding element is placed, in particular, relative to vertical guiding elements which are arranged in each case in pairs at different depth positions. As a result, the stability of the guidance is further improved in these two aforementioned spatial directions. The precision and tolerance-minimized coupling between the guiding elements and the respective guide tracks are also improved thereby.

In one exemplary embodiment, the at least one side guiding element is arranged between two guiding elements, in particular vertical guiding elements, which are arranged at different vertical positions, when viewed in the vertical direction. It is possible that the guiding elements, which make contact with the top guide track and the bottom guide track, have a first pair of such guiding elements which are arranged offset to one another in the vertical direction, in particular are arranged at different vertical positions, wherein the at least one side guiding element is arranged therebetween when viewed in the vertical direction. In one exemplary embodiment, however, the side guiding element can be arranged offset to this pair of guiding elements in the depth direction.

The guiding elements of the pair, which make contact with the top and bottom guide track, can be positioned at the same depth position in the depth direction.

The same can also be provided, as has been set forth above, for a further pair of guiding elements which make contact with the top guide track and the bottom guide track. In one exemplary embodiment, the respective positioning of the side guiding element can also be configured between these two further guiding elements in the vertical direction, in particular additionally offset to the front in the depth direction.

Preferably, it is provided that two guiding elements make contact with the bottom guide track from above and that at least two further guiding elements make contact with the top guide track from below. Thus four guiding elements are provided, in particular only and exactly four vertical guiding elements, which are mechanically coupled in pairs to the top guide track and the bottom guide track for sliding along or rolling along. In particular, a very symmetrical concept of the arrangement of the guiding elements, in particular the vertical guiding elements, can be achieved thereby. The precision of the movement guidance of the guide carriage is further improved thereby.

In one exemplary embodiment, at least one guiding element can be a roller. It is possible that all of the guiding elements are formed by rollers. This enables a particularly uniform and smooth movement of the guide carriage along the guide tracks.

In a further exemplary embodiment, at least one guiding element can be a plain bearing. It is possible that all of the guiding elements are configured as plain bearings. In such an exemplary embodiment, the guiding elements can be designed to be very space-saving and compact. As a result, the design of the guide carriage is also minimized, in particular in the vertical direction. A plain bearing is arranged, in particular, on the guide carriage without the possibility of its own relative movement.

In one exemplary embodiment, the bottom guide track is configured in a linear manner. In particular, the bottom guide track extends horizontally in the depth direction of the cooking appliance. Such a linear guide track requires practically no space in the vertical direction, since it does not have a curvature or a curved section. A space-saving concept, when viewed in the vertical direction, can be further improved thereby.

In one exemplary embodiment, the top guide track is configured in a linear manner. In particular, the top guide track extends horizontally in the depth direction of the cooking appliance. Advantages can also be achieved thereby regarding a compact design in the vertical direction. This also advantageously contributes to the stowage space being able to be reduced in terms of height and thus the cooking chamber being able to be enlarged.

It is also possible, however, that a guide part is configured in two parts. In this context, a first guiding sub-element can comprise the top guide track. A second guiding sub-element can comprise the bottom guide track. In such an exemplary embodiment, the guiding sub-elements can also be arranged spaced apart from one another, when viewed in the vertical direction.

In one exemplary embodiment, the guide carriage is coupled to the door by a hinge device of the cooking appliance. The pivoting movement of the door is assisted by this hinge device, when retracted into the stowage space and when extended out of the stowage space, so that this pivoting movement can be carried out independently of the displacement movement of the guide carriage. In particular, the hinge device can be fixedly arranged in the housing of the cooking appliance, when viewed as a whole. In particular, in this case the arrangement can be configured on a bottom subassembly of the housing. Preferably, the hinge device has separate guide components, such as for example the rollers. In one exemplary embodiment, these rollers can engage in slotted guides, such as in particular guide grooves, which are configured laterally on the door. Thus the door, in particular the door leaf of the door, can be moved relative to the hinge device and is guided in terms of movement by these engaging guiding elements of the hinge device. It is also possible that the door, in particular the door leaf, has a coupling device on a lower partial region. This coupling device is provided for coupling to the guide carriage. In particular, this coupling, which is configured in an articulated manner, is permanently configured so that the door leaf of the door can be moved, in particular can also be pivoted, relative to the guide carriage. In particular, it is provided that this coupling between the coupling device and the guide carriage is configured in an articulated manner.

In one exemplary embodiment, at least one guiding element can be mounted on a carrier of the guide carriage so as to be changeable in terms of position, when viewed as whole. As a result, the guiding element can be particularly advantageously in continuous contact with the guide track. It is then possible to compensate for tolerances by changing the position of the guiding element on the carrier. In one exemplary embodiment, the at least one guiding element can be arranged so as to be spring-mounted on the carrier. The change in position is made possible automatically by the spring force of the spring acting on the guiding element. A particularly advantageous, robust and very rapid system regarding the change in position is provided thereby.

Preferably, in each case a guide carriage and in each case a guide part are configured at opposing ends, when viewed in the width direction of the cooking appliance. The two guide carriages and/or the two guide parts can be configured identically. In particular, the above-mentioned descriptions and exemplary embodiments apply to both guide carriages. The above-mentioned coupling device can also be coupled to both guide carriages, in particular a connecting rod, which connects the two guide carriages.

The guide carriages, which are configured on opposing sides, are preferably connected to a connecting rod, so that the position relative to one another can be maintained and a tilting or twisting relative to one another does not occur regarding the movement. A smooth and uniform movement along the guide tracks is made possible by this positional coupling between the guide carriages. The door is advantageously connected at its lower end to these guide carriages, in particular rotatably connected thereto. The guide carriages are separate components from the hinge devices. The guide carriages are preferably connected to the door so as to be coupled in terms of movement, wherein an axis of rotation about which the door can rotate relative to a guide carriage is configured at the connecting point. Accordingly, the hinge device, with the rollers already described above, not only enables a relative movement regarding a rotation to one another but the guide grooves or guide tracks in the door, which are also configured on the side edges and have been already mentioned, can also provide a relative displacement movement between the door and a hinge arm.

In one exemplary embodiment, at least one guide track is configured to be channel-like. This enables the guide track to be defined perpendicularly to the longitudinal axis of the guide track. Thus an undesired movement of a guiding element perpendicular to the longitudinal axis of the guide track is limited, and in particular avoided. A particularly linear guidance of the guiding element in the guide track, in particular in the depth direction, is achieved thereby.

In one exemplary embodiment, at least one guide track is configured to be hump-like, when viewed in cross section and thus perpendicularly to its longitudinal axis. In particular, the guide track can be curved in a convex manner or designed to be trapezoidal. Such a shape of the guide track also avoids undesired slippage of the guiding element relative to the guide track, when viewed in the width direction. Such a shape of the guide track also achieves a particularly linear guidance of the guiding elements on the guide track.

In one exemplary embodiment, a running surface of a guiding element has a groove-like shape into which the hump-like region of the guide track engages. The above-mentioned advantages are assisted to a particular degree due to these complementary shapes of the running surface of the guiding element, on the one hand, and of the guide track, on the other hand.

In one advantageous embodiment, it is provided that the stowage space has at least at an entry point a clear width of less than or equal to 45 mm, in particular between 40 mm and 44 mm, in the vertical direction. Preferably, when viewed in the vertical direction, it is provided that this clear width is configured over at least 50 percent, preferably at least 80 percent, in particular at least 90 percent, of the depth of the stowage space measured in the depth direction.

By means of such an embodiment, the stowage space is of particularly compact design, so that the cooking chamber can be provided with maximum dimensions. If the housing of the cooking appliance has a conventional standard size, the cooking chamber can be maximized by this compact stowage space. However, the retracting and extending of a wide door into or out of the stowage space is still enabled.

In one advantageous embodiment, it is provided that the door has a thickness of between 35 mm and 45 mm, in particular between 38 mm and 42 mm, preferably 40 mm. In such an embodiment, it is also made possible that the door has a multi-pane package with at least three panes, wherein a front pane, an inner pane and at least one interposed intermediate pane can be provided in this case. The panes are oriented parallel to one another and represent plate-like elements, in particular made of real glass. Specifically with a plurality of door panes, in particular at least four such separate panes, the cooking appliance can also be configured, in particular, with a pyrolysis function.

Specifically in such an embodiment in which the door has the above-mentioned advantageous thickness, and the stowage space has the above-mentioned advantageous height dimension, wherein the thickness is naturally always smaller than the height dimension of the stowage space, in this regard a relatively thick door can be retracted into a stowage space which is only slightly higher. The above-mentioned mechanism thus enables a corresponding retracting process or extending process of the door to be made possible, although the stowage space is only slightly higher than the thickness of the door. In particular, this is achieved by the door not retracting, or retracting only slightly, into the stowage space during the pivoting movement, in particular starting from the closed position into a horizontal open position, and the principal retracting movement taking place starting from the horizontal open position, so that the linear movement of the door into the stowage space takes place only substantially after the pivoting movement.

In an advantageous embodiment, additionally or alternatively it can be provided that the door has on its outer face a width of between 530 mm and 545 mm, in particular between 535 mm and 540 mm, when viewed in the width direction. The configuration of the gap dimensions can be improved by such a wide door. In particular, in this context it is possible to improve the gap dimensions relative to adjacent components, such as for example front strips which are configured on the front face as visible components or external parts of the cooking appliance. In particular, these gap dimensions can be adjusted to be relatively small. In this context, the above-mentioned embodiment of the door with its specific width dimension enables a uniform appearance to be achieved on the front side between the cooking appliance variants, on the one hand only with a folding door and on the other hand with the above-described retractable door. A uniform appearance can be provided in the closed state of the doors in these two cooking appliance variants.

Advantageous embodiments of the above-mentioned aspect of the cooking appliance are to be regarded as advantageous embodiments of this further independent aspect of the cooking appliance.

The positions and orientations provided when the appliance is used as intended and arranged as intended and when an observer is standing in front of the appliance and looking in the direction of the appliance are specified by the terms “top” “bottom”, “front”, “rear”, “horizontal”, “vertical”, “depth direction”, “width direction”, “vertical direction”, etc.

Further features of the invention are found in the claims, the figures and the description of the figures. The features and combinations of features mentioned above in the description and the features and combinations of features mentioned below in the description of the figures and/or shown individually in the figures are not only able to be used in the respectively specified combination but also in other combinations without departing from the scope of the invention. Thus embodiments of the invention, which are not explicitly shown and described in the figures but which emerge and can be produced from separate combinations of features from the described embodiments, are to be regarded as encompassed and disclosed. Embodiments and combinations of features which thus do not have all of the features of an originally formulated independent claim are also to be regarded as disclosed. Embodiments and combinations of features, in particular through the embodiments set forth above, which go beyond or deviate from the combinations of features set forth in the references of claims are also to be regarded as disclosed.

Exemplary embodiments of the invention are explained in more detail below with reference to schematic drawings, in which:

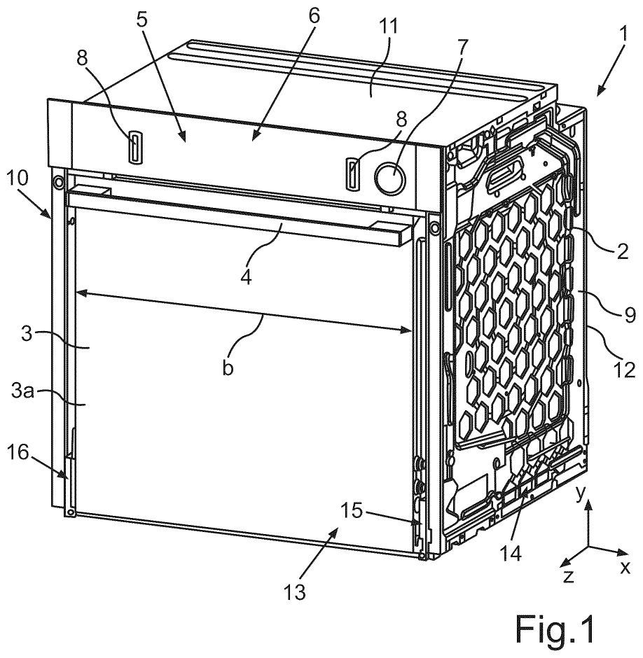

FIG. 1 shows a perspective view of an exemplary embodiment of a cooking appliance according to the invention;

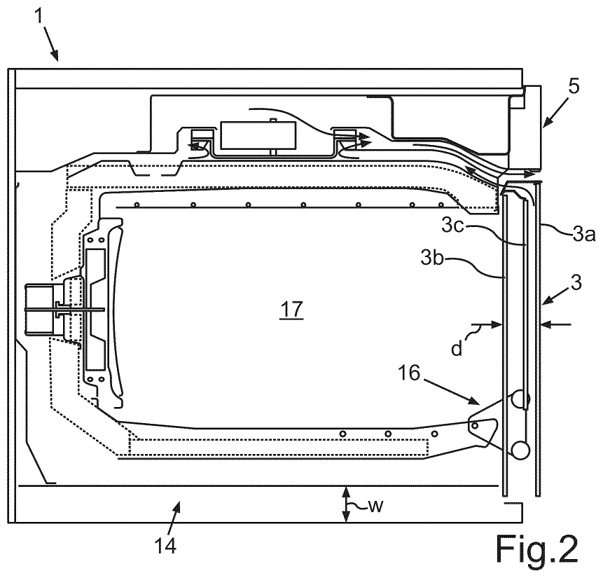

FIG. 2 shows a schematic vertical sectional view through the cooking appliance according to FIG. 1;

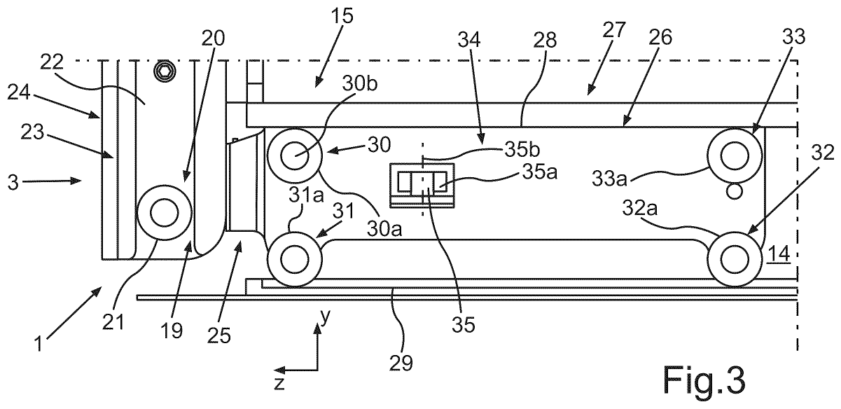

FIG. 3 shows a side view of an exemplary embodiment of a partial region of the cooking appliance according to FIG. 1 with a view of a guide carriage and a guide part;

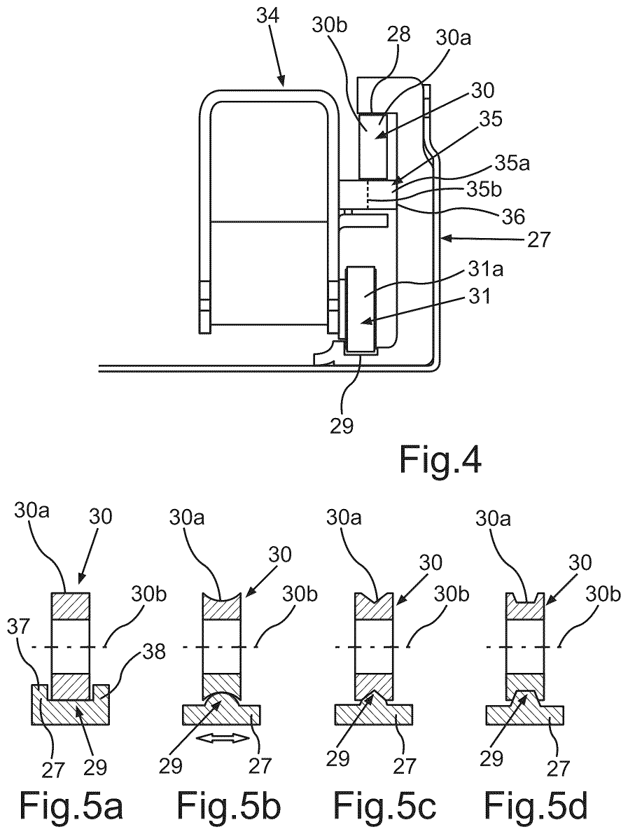

FIG. 4 shows a front view of the arrangement according to FIG. 3; and

FIGS. 5a to 5d show exemplary sectional views through exemplary embodiments of shapes of rollers of the guide carriage and shapes of guide tracks.

Elements which are identical or functionally identical are provided with the same reference signs in the figures.

A household appliance 1, which is configured as an oven, is shown in a schematic perspective view in FIG. 1. The household appliance 1 has a housing 2 in which a cooking chamber which is defined by a muffle, not shown, is configured. Food can be introduced into the cooking chamber for preparation. The cooking chamber can be closed on the front side by a door 3 which is shown in FIG. 1 in the closed end position. A handle 4 is configured on the front side of the door 3.

Moreover, the oven has a control device 5 which has a display unit 6 and control elements 7 and 8, merely by way of example in terms of position and display.

The housing 2 can have walls 9, 10, 11 and 12.

In its lower region 13 the door 3 can be inserted or retracted into the housing 2 which is the case when transferring the door 3 from the closed end position shown in FIG. 1 into the fully open and retracted end position. The door 3 is thus arranged so as to be inserted by being retracted into a free space of the housing 2, wherein a stowage space 14, which is arranged below the cooking chamber and separated therefrom by a corresponding partition, is formed by this free space.

The door 3 is connected to door hinges, which are shown and identified by way of example and which are examples of hinge devices 15 and 16, and can be pivoted thereby and retracted into and extended from the aforementioned stowage space 14.

A vertical sectional view (cutting plane y-z plane) of the cooking appliance 1 is shown in FIG. 2. The cooking chamber 17, which is defined by the aforementioned muffle, can be identified here.

It can be identified here that the stowage space 14 has a clear width w which is measured in the vertical direction (y-direction) and which is, in particular, between 40 mm and 44 mm, preferably between 42 mm and 43 mm.

A thickness d (FIG. 2) of the door 3 is preferably between 38 mm and 42 mm, in particular 40 mm.

A width b of the door 3, measured in the width direction (x-direction) as illustrated in FIG. 1, is preferably between 530 mm and 545 mm, in particular between 535 mm and 540 mm.

A front pane 3a and an inner pane 3b and an intermediate pane 3c of the door 3 are also shown.

As shown in FIG. 3, which represents a view in the negative x-direction, the hinge device 15 can have a hinge housing 18. This hinge device can be fixedly arranged in the housing 2. The hinge device 15 also has a bearing unit 19 which has a bearing bracket 20. At least one guiding element 21, in this case a roller, is rotatably mounted on the bearing bracket 20. This guiding element 21 engages in a groove-like slotted guide 22 which is configured on a side edge 23 of the door 3 and in the closed state of the door 3 extends in the vertical direction. The guiding element 21 is thus guided in this slotted guide 22 which is open laterally to the outside, when viewed in the width direction.

The slotted guide 22 is configured, in particular, on a door leaf 24 of the door 3. The door leaf 24 is the plate-like element of the door 3 on the front side.

The door 3 also has a coupling device 25. The door leaf 24 is coupled by this coupling device 25 to at least one guide carriage 26 of the door 3. In particular, a guide carriage 26 is arranged in each case on opposing sides in the width direction. In particular, an articulated connection is configured here so that in the state coupled to the guide carriage 26 the door leaf 3 can be pivoted in an articulated manner relatively, in particular about an axis oriented in the width direction (x-direction).

The cooking appliance 1 also has a guide part 27. The guide part 27 is arranged in the stowage space 14. In particular, a guide part 27 is arranged in each case on opposing sides in the width direction.

The guide carriage 26 is guided on this guide part 27. The guide part 27 can be configured to be rod-like or bar-like. The guide part extends with its longitudinal axis in the depth direction (z-direction) of the cooking appliance 1. In particular, the guide part is arranged on a side wall which laterally defines the stowage space 14. In the exemplary embodiment shown, the guide part 27 has a top guide track 28, when viewed in the vertical direction (y-direction) of the cooking appliance 1. In one exemplary embodiment, this top guide track 28 is linear, in particular over at least the portion along which the guide carriage 26 can move, in particular, with a guiding element. Moreover, the guide part 27 has a bottom guide track 29, when viewed in the vertical direction. This bottom guide track is arranged below the top guide track 28. In one exemplary embodiment, the bottom guide track 29 is configured to be linear, in particular over at least the portion over which the guide carriage 26 can move with guiding elements.

The two guide tracks 28 and 29 are oriented, in particular, parallel to one another.

The guide carriage 26, shown here, is the right-hand guide carriage, when viewing the cooking appliance 1 from the front side. In one exemplary embodiment, the cooking appliance 1 has a second guide carriage 26. This second guide carriage can preferably be designed corresponding to the guide carriage 26. It is a left-hand guide carriage, when viewing the cooking appliance 1 from the front side. If two such guide carriages 26 are present, they can be connected to a connecting stand, not shown, which extends in the width direction.

In one exemplary embodiment, the guide carriage 26 has a plurality of, in this case in particular exactly four, separate guiding elements 30, 31, 32 and 33. In the exemplary embodiment in FIG. 3, only these four guiding elements 30 to 33 which are arranged on this illustrated guide carriage 26 and which roll on the guide tracks 28 and 29 are present in this case. In the exemplary embodiment, these guiding elements 30 to 33 are all configured in each case as a roller. The guiding elements 30 to 33 have running surfaces 30a, 31a, 32a and 33a.

As can also be identified in FIG. 3, the preferably four guiding elements 30, 31, 32 and 33 are arranged in pairs relative to one another, both in the vertical direction and in the depth direction. Thus the guiding elements 30 and 31 are arranged offset to one another in the vertical direction but at the same depth position in the depth direction. Thus the guiding elements form a pair of front guiding elements 30 and 31. These guiding elements 30 and 31 can also be denoted as vertical guiding elements. This is because the guiding elements with their running surfaces 30a and 31a are in mechanical contact with guide tracks, namely the top guide track 28 and the bottom guide track 29, which are configured to be offset thereto in each case in the vertical direction.

In the exemplary embodiment, it is provided that a further pair of guiding elements 32 and 33 is configured. These guiding elements are also vertical guiding elements. They are arranged offset to one another in the vertical direction but are arranged at the same depth position to one another in the depth direction. In this case, these guiding elements 32 and 33 with their running surfaces 32a and 33a are also in direct contact with guide tracks 28 and 29 which are offset thereto in the vertical direction.

As can also be identified, the front top guiding element 30 is arranged at the same vertical position as the rear top guiding element 33. Moreover, the front bottom guiding element 31 is arranged at the same vertical position as the rear bottom guiding element 32. As can be identified, the top guiding elements 30 and 33 make contact with the top guide track 28 from below. Moreover, the bottom guiding elements 31 and 32 make contact with the bottom guide track 29 from above.

The guiding elements 30 to 33 are arranged on a carrier 34 of the guide carriage 26.

As can also be identified from the view in FIG. 3, the guide carriage 26 has at least one further guiding element which in this case is a side guiding element 35. This means that, in contrast to the other guiding elements 30 to 33, it is not provided for direct contact with the guide tracks 28 and 29 offset thereto in the vertical direction, but it is provided for making contact as intended with a guide track offset thereto in the width direction and thus a lateral guide track 36 (FIG. 4). In this case, only one such side guiding element 35 is provided. It has a running surface 35a which is configured for direct contact with this lateral guide track 36. The side guiding element 35 can be configured, in particular, as a roller. Thus it preferably has an axis of rotation 35b. This axis of rotation is vertically oriented by way of example and thus oriented in the vertical direction. It is also possible, however, that this axis of rotation 35b is tilted about an angle relative to the vertical. This side guiding element can thus also be arranged inclined upwardly or downwardly. In particular, the surface area of the lateral guide track 36 provided for the contact can be correspondingly inclined, so that the running surface 35a also makes contact with and can roll extensively on this lateral guide track 36.

As shown in FIG. 3, this side guiding element 35 is also arranged on the carrier 34, in this case the other guiding elements 30 to 33 preferably being rotatably mounted thereon.

The side guiding element 35 is arranged in this case between the guiding elements 30 and 31 and/or between the guiding elements 32 and 33, when viewed in the vertical direction. This side guiding element 35 is offset to the rear relative to the guiding elements 30 and 31 when viewed in the depth direction. The side guiding element is arranged so as to be offset to the front relative to the guiding elements 32 and 33, in particular when viewed in the depth direction.

At least one guiding element 30, 31, 32, 33 and/or the at least one side guiding element 35 can be arranged so as to be spring-mounted on the carrier 34. This means, in particular, that the guiding elements 30, 31, 32 and 33 can be arranged so as to be spring-mounted in the vertical direction and the side guiding element 35 can be arranged so as to be spring-mounted in the width direction.

In FIG. 4 the view of the components in FIG. 3 is shown in a front view and thus the right-hand embodiment in the cooking appliance according to FIG. 1. In particular, it is possible that a corresponding further guide carriage 26, as shown in FIG. 3, is also arranged on the left-hand side in the stowage space 14 of the cooking appliance 1, so that in each case such a guide carriage is present opposingly in the width direction. At this left-hand position of the stowage space 4, it is also possible to provide a corresponding guide part 27 on which this further guide carriage 26 is arranged so as to be relatively movable thereto. In such an exemplary embodiment, the two guide carriages 26 can be connected together by a connecting rod, so that they are rigidly coupled together and are guided in parallel in the depth direction. In one exemplary embodiment, this connecting rod can also be a component of the coupling device 25.

Exemplary embodiments of shapes for the running surfaces of guiding elements and shapes of guide tracks are shown in FIG. 5a to FIG. 5d. The sectional views, which are shown in each case here, are not understood to be definitive but are intended to represent only a few possible examples. Thus a guiding element 30 with its running surface 30a is shown by way of example in FIG. 5a. The guide track 28, shown here by way of example, is preferably defined laterally by defining walls 37 and 38, when viewed in the width direction. As a result, a channel-like shape of the guide track 28 is formed in this cross-sectional view, which is formed perpendicularly to the longitudinal axis of the guide track 28. An axis of rotation 30b, about which a guiding element 30 which is configured as a roller can rotate, is also illustrated. In this exemplary embodiment, the running surface 30 in this cross-sectional view is configured in a linear manner.

A view corresponding to FIG. 5a is shown in FIG. 5b, wherein the running surface 30a is configured to be groove-like in this case. In particular, the running surface is curved in a concave manner. In the exemplary embodiment shown here, it is provided that the guide track 28 is formed in a hump-like manner. In particular, the guide track has a dome which is curved in a convex manner. As a result, the running surface 30a is positioned with its concave shape on this guide track 28 which is curved in a convex manner. In this case, in particular, a slippage or displacement of the guiding element 30 relative to the guide track 28, taking place in the width direction, is avoided or significantly restricted. An exemplary embodiment similar to FIG. 5b is shown in FIG. 5c. The groove-like shape of the running surface 30a is different in this case from the exemplary embodiment in FIG. 5b. In this case, this groove-like shape in cross section is in the manner of a notch, in particular in the manner of a V-shaped notch, so that a continuous concave curved region is not formed. In FIG. 5d a further exemplary embodiment is shown. In this exemplary embodiment, the running surface 30a is also configured in a groove-like manner. In this case the contour, however, is angular. Preferably, a trapezoidal cross-sectional shape of the guide track 28 is adapted thereto. In this case, a corresponding interlocking is also implemented in turn, as shown in FIG. 5d.

### LIST OF REFERENCE SIGNS

1 Oven
2 Housing
3 Door
3a Front pane
3b Inner pane
3c Intermediate pane
4 Handle
5 Control device
6 Display unit
7 Control element
8 Control element
9 Wall
10 Wall
11 Wall
12 Wall
13 Region
14 Stowage space
15 Hinge device
16 Hinge device
17 Cooking chamber
18 Hinge housing
19 Bearing unit
20 Bearing bracket
21 Guiding element
22 Slotted guide
23 Side edge
24 Door leaf
25 Coupling device
26 Guide carriage
27 Guide part
28 Top guide track
29 Bottom guide track
30 Guiding element
30a Running surface
31 Guiding element
31a Running surface
32 Guiding element
32a Running surface
33 Guiding element
33a Running surface
34 Carrier
35 Side guiding element
35a Running surface
35b Axis of rotation
36 Guide track
37 Defining wall
38 Defining wall
A Longitudinal axis
b Width
d Thickness
W Width

1-15. (canceled)

16. A cooking appliance, comprising:
a door for closing a cooking chamber;
a housing designed to form a stowage space into which the door is retractable;
a guide carriage; and
a guide part arranged in the stowage space for guiding the guide carriage in a retracting movement of the door into the stowage space, said guide part comprising, when viewed in a vertical direction of the cooking appliance, a top guide track and a separate bottom guide track,
wherein the guide carriage comprises guiding elements which make contact with the top guide track and the bottom guide track in order to guide the guide carriage, with at least one of the guiding elements resting on the bottom guide track from above and at least a further one of the guiding elements making contact with the top guide track from below.

17. The cooking appliance of claim 16, further comprising a lateral guide track designed to laterally guide the guide carriage in a width direction of the cooking appliance, said guide carriage comprising a side guiding element which is separate from the guiding elements and is designed for placement on the lateral guide track.

18. The cooking appliance of claim 17, wherein at least one of the guiding elements and/or the side guiding element is a roller.

19. The cooking appliance of claim 17, wherein at least one of the guiding elements and/or the side guiding element is a plain bearing.

20. The cooking appliance of claim 17, wherein, when viewed in a depth direction of the cooking appliance, two of the guiding elements are front guiding elements and two of the guiding elements are rear guiding elements, said side guiding element being arranged between the two front guiding elements and the two rear guiding elements.

21. The cooking appliance of claim 17, wherein the guide carriage comprises a carrier, said side guiding element being mounted on the carrier of the guide carriage such that a position of the side guiding element as a whole is changeable.

22. The cooking appliance of claim 17, wherein the lateral guide track is designed in a form of a channel or the lateral guide track is designed in a form of a hump in cross section.

23. The cooking appliance of claim 22, wherein the lateral guide track in hump form is curved in a convex manner or is trapezoidal.

24. The cooking appliance of claim 16, wherein two of the guiding elements make contact with the bottom guide track and at least two further guiding elements make contact with the top guide track.

25. The cooking appliance of claim 16, wherein at least one member selected from the group consisting of the bottom guide track and the top guide track is designed in a linear manner.

26. The cooking appliance of claim 25, wherein the member extends horizontally in a depth direction of the cooking appliance.

27. The cooking appliance of claim 16, further comprising a coupling device designed to couple the guide carriage to a door leaf of the door.

28. The cooking appliance of claim 27, wherein the coupling device is designed to effect a coupling between the coupling device and the guide carriage in an articulated manner.

29. The cooking appliance of claim 16, wherein the guide carriage comprises a carrier, at least one of the guiding elements being mounted on the carrier of the guide carriage such that a position of the at least one of the guiding elements as a whole is changeable.

30. The cooking appliance of claim 17, wherein the guide carriage comprises a carrier, at least one of the guiding elements and/or the side guiding element being arranged so as to be adjustable and/or spring-mounted on the carrier.

31. The cooking appliance of claim 16, wherein at least one of the top guide track and the bottom guide track is designed in a form of a channel or at least one of the top guide track and the bottom guide track is designed in a form of a hump in cross section.

32. The cooking appliance of claim 31, wherein the at least one of the top guide track and the bottom guide track in hump form is curved in a convex manner or is trapezoidal.

33. The cooking appliance of claim 31, wherein each of the guiding elements includes a running surface in a shape of a groove for engagement of a hump-shaped region of the at least one of the top guide track and the bottom guide track.

34. The cooking appliance of claim 16, wherein the stowage space includes an entry point at a clear width of less than or equal to 45 mm, in particular between 40 mm and 44 mm, in a vertical direction and/or the door has a thickness of between 35 mm and 45 mm, in particular between 38 mm and 42 mm, and/or the door, in particular a front pane, includes an outer face at a width of between 530 mm and 545 mm, in particular between 535 mm and 540 mm.
